(19) United States
(12) Patent Application Publication
(10) Pub. No.: US 2010/0166328 A1
(43) Pub. Date: Jul. 1, 2010

(54) IMAGE ENCODER AND IMAGE ENCODING METHOD

(76) Inventor: Jung-Wook Kim, Gwanak-gu (KR)

Correspondence Address: SHERR & VAUGHN, PLLC, 620 HERNDON PARKWAY, SUITE 320, HERNDON, VA, 20170, US

(21) Appl. No.: 12/646,508

(22) Filed: Dec. 23, 2009

(30) Foreign Application Priority Data
Dec. 30, 2008 (KR) 10-2008-0137536

(51) Int. Cl. G06K 9/46; G06K 9/36

(52) U.S. Cl. 382/243; 382/251

(57) ABSTRACT

The image encoder includes a block arrangement unit configured to chromatically subsample an externally input image signal and to arrange the image signal in units of a plurality of blocks, a plurality of Discrete Cosine Transform (DCT) units configured to perform DCT with respect to the image signal divided into the plurality of blocks, a plurality of quantization units configured to quantize the outputs of the plurality of DCT units, a delta modulation unit configured to perform Differential Pulse Code Modulation (DPCM) with respect to the outputs of the plurality of quantization units, a plurality of Huffman encoding units configured to encode the outputs of the delta modulation units using a Huffman encoding method, and a code connection unit configured to reconstruct the signals output from the plurality of Huffman encoding units in constant bit units and to output a compressed image signal. Since the image is encoded in parallel, it is possible to increase encoding speed.

The present application claims priority under 35 U.S.C. §119 to Korean Patent Application No. 10-2008-0137536 (filed on Dec. 30, 2008), which is hereby incorporated by reference in its entirety.

### BACKGROUND

Generally, Joint Photographic Experts Group (JPEG) is a compression standard for a still image, in which a raw image is compressed into a JPEG image in the following order. The raw image is chromatically subsampled, is subjected to Discrete Cosine Transform (DCT), and is quantized. The quantized signal is Huffman-coded to be converted into the JPEG compressed image.

Recently, as the size of images subjected to JPEG compression increases, a high-speed JPEG encoder is required. In order to solve this problem, two JPEG encoders were included, and a parallel processing method of compressing a first frame using a first encoder and compressing a second frame using a second encoder was used.

However, if two JPEG encoders are included, the area of a chip is increased and power consumption is increased. In particular, table memories used for quantization and Huffman coding are redundant and the table memories have significant influence on the area and power consumption, rather than a logic circuit. In addition, for JPEG compression, a memory should store two or more images. However, if the sizes of the images are large, two or more images cannot be stored, and thus, an external memory may be necessary. The use of the external memory leads to increase in the overall cost of the system. Also, since the speed of the basic JPEG encoder is not high, data is stored in the memory and is then read from the memory for compression. Meaning, on-the-fly compression may not be performed. In such a method, since the bandwidth of an on-chip bus is sacrificed for compression, overall system deterioration is caused and a user must spend considerable time waiting for a finally compressed image.

As another method for increasing a JPEG encoding speed, a method for increasing an operating frequency of a JPEG encoder was used. For example, if a JPEG encoder with an operating frequency of 100 MHz operates at 200 MHz, the speed thereof is doubled.

However, if the operating frequency of the JPEG encoder is increased, the operating frequency of the overall system and the operating frequency of the JPEG encoder may not be equal to each other. If the JPEG encoder with the increased operating frequency is used in the system, a logic circuit for asynchronous data transmission should be added. Since it is difficult to test such a logic circuit, the probability of failure occurring increases. In addition, if the operating frequency of the JPEG encoder is increased, many efforts are necessary for a backend for manufacturing a chip. As a result, a development period is increased.

### SUMMARY

Embodiments relate to an image encoder and image encoding method which increases image compression speed.

Embodiments relate to an image encoder and image encoding method which compresses an image at a high speed without changing an operating frequency.

In accordance with embodiments, an image encoder can include at least one of the following: a block arrangement unit configured to chromatically subsample an externally input image signal and to arrange the image signal in units of a plurality of blocks, a plurality of Discrete Cosine Transform (DCT) units configured to perform DCT with respect to the image signal divided into the plurality of blocks, a plurality of quantization units configured to quantize the outputs of the plurality of DCT units, a delta modulation unit configured to perform Differential Pulse Code Modulation (DPCM) with respect to the outputs of the plurality of quantization units, a plurality of Huffman encoding units configured to encode the outputs of the delta modulation units using a Huffman encoding method, and a code connection unit configured to reconstruct the signals output from the plurality of Huffman encoding units in constant bit units and to output a compressed image signal.

In accordance with embodiments, the delta modulation unit may obtain a difference in DC level between the same color spaces of the outputs of the plurality of quantization units and perform DPCM.

In accordance with embodiments, the delta modulation unit may compare any one of the blocks of the outputs of the plurality of quantization units with other blocks, determine the input order of the blocks, and perform the DPCM.

In accordance with embodiments, the delta modulation unit may further include a circuit for dividing the blocks of the outputs of the plurality of quantization units and inserting a reset marker in constant units, and determine whether the blocks are subjected to the DPCM through the reset marker.

In accordance with embodiments, the code connection unit may divide the outputs of the plurality of Huffman encoding units in the same bit unit as the data used in an external memory for storing the compressed image signal so as to perform reconstruction.

In accordance with embodiments, the code connection unit may further include a circuit for dividing the outputs of the plurality of Huffman encoding units in constant block units and inserting a reset marker.

In accordance with embodiments, the image encoder may further include a temporary memory, and the temporary memory may store the outputs of the plurality of Huffman encoding units and then provide the outputs to the code connection unit.

In accordance with embodiments, the temporary memory may include a register for storing a valid bit size of last data and provide the valid bit size of the last data to the code connection unit when the codes of the outputs of the plurality of Huffman encoding units are connected by the code connection unit.

In accordance with embodiments, the compressed image signal may be a Joint Photographic Experts Group (JPEG) encoded image signal.

In accordance with embodiments, an image encoding method include can include at least one of the following: chromatically sub-sampling an externally input image signal and arranging the image signal in the units of a plurality of blocks, performing Discrete Cosine Transform (DCT) with respect to the image signal divided into the plurality of blocks, quantizing the DCT signals, performing Differential Pulse Code Modulation (DPCM) with respect to the quantized signals, performing Huffman encoding with respect to the DPCM signals, and reconstructing the Huffman-encoded signals in constant bit units and outputting a compressed image signal.

In accordance with embodiments, an image encoder can include at least one of the following: a block arrangement unit configured to chromatically subsample an externally input image signal and arrange the image signal in units of a plurality of blocks; a plurality of Discrete Cosine Transform (DCT) units configured to perform DCT with respect to the image signal divided into the plurality of blocks; a plurality of quantization units configured to quantize the outputs of the plurality of DCT units; a delta modulation unit configured to perform Differential Pulse Code Modulation (DPCM) with respect to the outputs of the plurality of quantization units, the delta modulation unit including a circuit configured to divide the blocks of the outputs of the plurality of quantization units, insert a reset marker in constant units, and determine whether the blocks are subjected to the DPCM through the reset marker; a plurality of Huffman encoding units configured to encode the outputs of the delta modulation units using a Huffman encoding method; and a code connection unit configured to reconstruct the signals output from the plurality of Huffman encoding units in constant bit units and to output a compressed image signal, the code connection unit including a circuit configured to divide the outputs of the plurality of Huffman encoding units in constant block units and insert a reset marker.

In accordance with embodiments, the DPCM may be performed by obtaining a difference in DC level between the same color spaces of the quantized signals.

In accordance with embodiments, the DPCM may be performed after comparing any one of the blocks of the quantized signals with the other blocks and determining the input order of the blocks.

In accordance with embodiments, the method may further include dividing the plurality of quantized signals and the Huffman-encoded signals into block units and inserting a reset marker when the plurality of quantized signals are subjected to DPCM and the Huffman-encoded signals are reconstructed in constant bit units.

In accordance with embodiments, the Huffman-encoded signals may be divided in the same bit units as data used in an external memory for storing the compressed image signal so as to be reconstructed.

In accordance with embodiments, the compressed image signal may be a Joint Photographic Experts Group (JPEG) encoded image signal.

In accordance with embodiments, since an image is encoded using a parallel processing method, it is possible to reduce the area of a circuit compared with a related structure using several encoders and to decrease manufacturing costs and power consumption. Moreover, since data provided from another image processing device is immediately processed and encoded using an on-the-fly method, it is possible to reduce memory bandwidth and to minimize system resource waste. In addition, since an operating frequency of an image encoder is equal to that of a system, it is possible to easily perform a backend operation of a circuit manufacturing process, to shorten a manufacturing period of a chip, and to easily perform inspection so as to minimize a transmission error when the chip is manufactured. Also, since the number of DCT units and quantization units which are the parallel processing units is optimized to suit each system, it is possible to flexibly design a high-performance encoder or cheap encoder according to circumferences. If the image encoding method of the present invention is applied to software, it is possible to complete image encoding in a short period of time by efficiently using a multi-core processor, which is frequently present in modern computing systems, rather than the existing algorithm.

### DRAWINGS

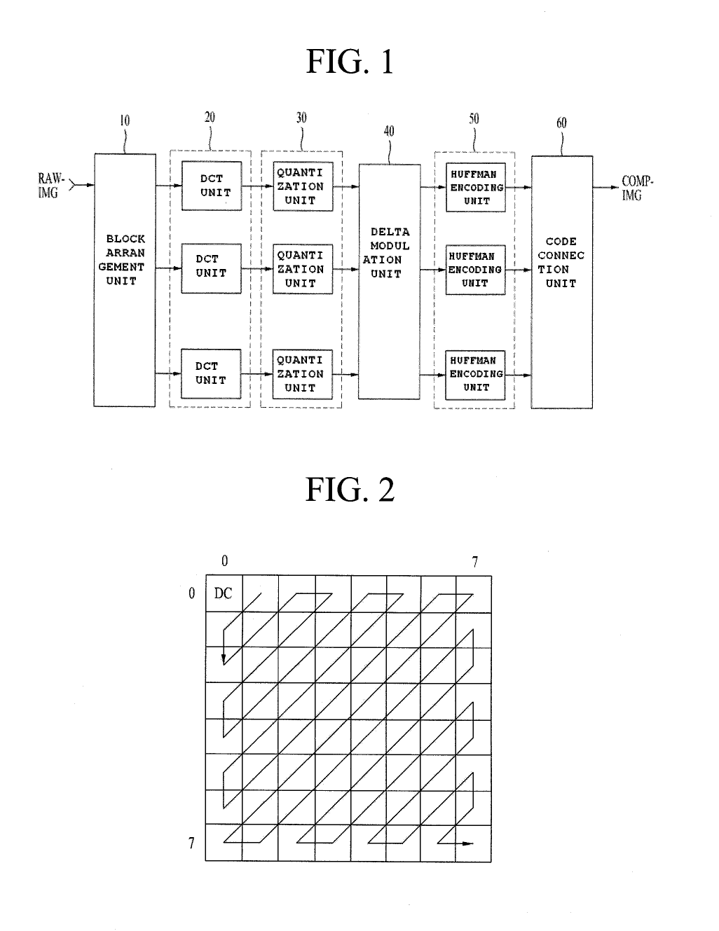

Example FIGS. 1 to 4 illustrate an image encoder, in accordance with embodiments.

### DESCRIPTION

Embodiments include an image encoder and image encoding method which enhances an image compression speed by performing Discrete Cosine Transform (DCT), quantization and Huffman encoding with respect to an image in parallel.

As illustrated in example FIG. 1, the image encoder in accordance with embodiments includes block arrangement unit 10, plurality of DCT units 20, plurality of quantization units 30, delta modulation unit 40, plurality of Huffman encoding units 50, and code connection unit 60. Block arrangement unit 10 chromatically subsamples and arranges image signal RAW_IMG in units of a plurality of blocks. The plurality of DCT units 20 and the plurality of quantization units 30 are included in number in correspondence with the number of image signal blocks arranged by block arrangement unit 10. The plurality of DCT units 20 performs DCT with respect to the image signal divided into the plurality of blocks, and the plurality of quantization units 30 quantizes the outputs of the plurality of DCT units 20. The plurality of DCT units 20 performs DCT with respect to the image signal using the structure illustrated in example FIG. 2.

As illustrated in example FIG. 2, if image signal RAW_IMG is divided into 8×8-pixel blocks, the 8×8 blocks are transformed into data of a frequency domain through DCT. At this time, a pixel located at a leftmost upper end of the transformed data is called a DC level. The DC level is information corresponding to a lowest frequency domain of block information, and generally has most information of the image. Accordingly, only a DC peripheral portion is left and the remaining portion is set to 0 in a direction denoted by an arrow so as to perform image compression.

As illustrated in example FIG. 1, delta modulation unit 40 performs Differential Pulse Code Modulation (DPCM) with respect to the outputs of the plurality of DCT units 20. Since the values of the images are averagely consecutive, the values of the DC levels of the blocks illustrated in example FIG. 2 are substantially similar. In order to use such a feature for compression, the DPCM is used. The DPCM is a technique of storing only a difference between a current value and a previous value, not storing a current value. Delta modulation unit 40 obtains a difference in DC level between the same color spaces. In a JPEG compression, color spaces of three channels Y, Cb and Cr are used. In the Y block, the DPCM is performed between the Y blocks and, in the Cb block, the DPCM is performed between the Cb blocks. In particular, since several blocks of one color, e.g., several Y blocks may be simultaneously input, delta modulation unit 40 determines which block is first input and obtains the value of the DPCM.

In JPEG compression, the input order of Y, Cb and Cr blocks are changed according to an input format. However, since the order of six blocks used in a 4:1:1 or 4:2:0 format is “Y0->Y1->Y2->Y3->Cb->Cr,” one of the six blocks is only compared with five other blocks. If N DCT units 20 and quantization units 30 are included, delta modulation unit 40 includes 6*N comparators in order to obtain the DPCM values. The DPCM values of all the blocks can be simultaneously obtained using such comparators. In addition, delta modulation unit 40 includes a reset (RST) marker function for determining whether the DPCM of each block is performed. Meaning, since the DC levels of all the blocks are connected through the DPCM, a JPEG compressed image is weak against an error generated in a JPEG code stream during transmission. This is because all the blocks are connected through the DPCM, and thus, if an error is generated in a block, all subsequent blocks are broken.

As a method for solving such a problem, a reset marker is used. A user may insert the reset marker at a constant block interval. Since the DPCM relationship between a previous block and a next block of a block, into which the reset marker is inserted, is eliminated, the image may be restored midway using the reset marker even when an error is generated in the JPEG code stream midway.

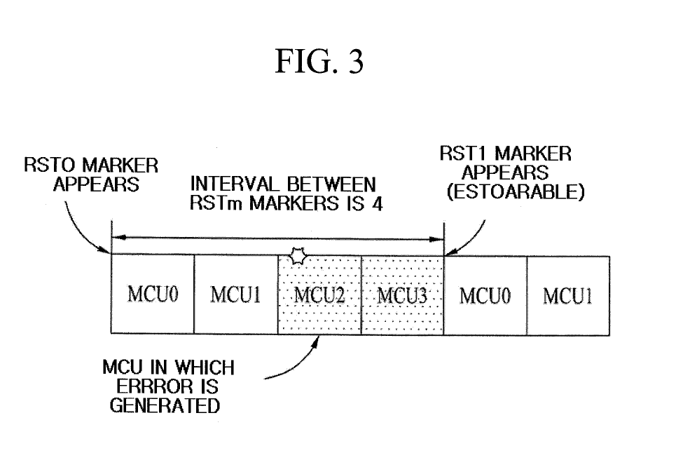

As illustrated in example FIG. 3, reset markers RST0 and RST1 may be inserted in the plurality of blocks in units of four blocks MCU0 to MCU3, and a block in which an error is generated may be restored using the reset markers RST0 and RST1. Since the image encoder in accordance with embodiments uses a parallel processing method, several blocks are simultaneously input to delta modulation unit 40. Accordingly, although the blocks are simultaneously input, any given block may or may not be subjected to DPCM. Accordingly, delta modulation unit 40 includes a circuit for determining whether the block is subjected to the DPCM while counting the number of input blocks. In addition, since the reset marker is inserted even when a finally encoded code is output, a circuit for counting the number of blocks and inserting the reset marker is preferably included in the below-described code connection unit 60.

As illustrated in example FIG. 1, the plurality of Huffman encoding units 50 is included in number in correspondence with the number of image signal blocks arranged by block arrangement unit 10, and encodes the outputs of delta modulation unit 40 using a Huffman encoding method. Since the Huffman encoding is variable length coding, the length of the code is about 1 bit or 2 bits. Code connection unit 60 reconstructs the signals output from the plurality of Huffman encoding units 50 in constant bit units and outputs a compressed image signal COMP_IMG. Meaning, the compressed image is stored in an external memory. Since data used in the external memory has a unit of constant bits, e.g., 8 bits, 16 bits and 32 bits, code connection unit 60 divides the outputs of the plurality of Huffman encoding units 50 in constant bit units, e.g., 8-bit units so as to perform reconstruction. For example, if a code A of “0100110”, a code B of “01010” and a code C of “1101110110” are present, the code connection unit 60 attaches all three codes, divides the codes by 8 bits (or 16 bits or 32 bits), and outputs the divided bits, when externally outputting the codes A, B and C. Meaning, the codes A, B and C are subjected to processes of “0100110010101101110110->01001100 10101101 110110->0x4C 0xAD 0xD8. At this time, since a last portion has only 6 bits, it is assumed that the remaining 2 bits are 0.

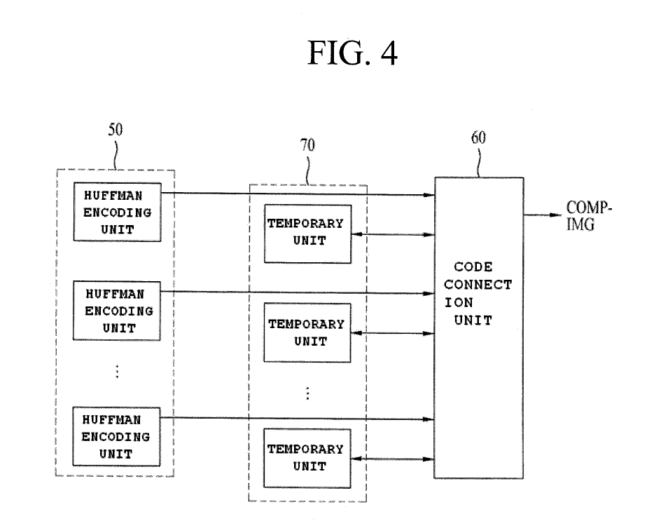

In the parallel image encoding method in accordance with embodiments, since the Huffman encoded results are simultaneously output, the image encoder according to the present invention may further include a plurality of temporary memories 70 as illustrated in example FIG. 4 such that a method for storing the Huffman encoded results and then reading and connecting the Huffman encoded results is used.

As illustrated in example FIG. 4, the outputs of the plurality of Huffman encoding units 50 are stored in the plurality of temporary memories 70 through code connection unit 60 and the size of the data output from the plurality of Huffman encoding units 50 is equal to the bit size of the plurality of temporary memories 70. If the data size is 8 bits, the bit size of one temporary memory 70 is also 8 bits. However, since the outputs of the plurality of Huffman encoding units 50 are not always in the 8-bit units, each of temporary memories 70 includes a register for storing the valid bit size of last data and provides the valid bit size to code connection unit 60 when the codes are finally connected. In the image encoder in accordance with embodiments, since a portion in which parallel processing is impossible is complemented by delta modulation unit 40 and code connection unit 60, it is possible to compress the image using parallel processing and to improve an image encoding speed.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a block arrangement unit configured to chromatically subsample an externally input image signal and arrange the image signal in units of a plurality of blocks;
a plurality of Discrete Cosine Transform (DCT) units configured to perform DCT with respect to the image signal divided into the plurality of blocks;
a plurality of quantization units configured to quantize the outputs of the plurality of DCT units;
a delta modulation unit configured to perform Differential Pulse Code Modulation (DPCM) with respect to the outputs of the plurality of quantization units;
a plurality of Huffman encoding units configured to encode the outputs of the delta modulation units using a Huffman encoding method; and
a code connection unit configured to reconstruct the signals output from the plurality of Huffman encoding units in constant bit units and to output a compressed image signal.

2. The apparatus of claim 1, wherein the delta modulation unit obtains a difference in DC level between the same color spaces of the outputs of the plurality of quantization units and performs the DPCM.

3. The apparatus of claim 1, wherein the delta modulation unit compares any one of the blocks of the outputs of the plurality of quantization units with other blocks, determines the input order of the blocks, and performs the DPCM.

4. The apparatus of claim 1, wherein the delta modulation unit comprises:
a circuit configured to divide the blocks of the outputs of the plurality of quantization units, insert a reset marker in constant units, and determine whether the blocks are subjected to the DPCM through the reset marker.

5. The apparatus of claim 1, wherein the code connection unit is configured to divide the outputs of the plurality of Huffman encoding units in the same bit unit as the data used in an external memory for storing the compressed image signal so as to perform reconstruction.

6. The apparatus of claim 1, wherein the code connection unit comprises:
a circuit configured to divide the outputs of the plurality of Huffman encoding units in constant block units and insert a reset marker.

7. The apparatus of claim 1, further comprising a temporary memory.

8. The apparatus of claim 7, wherein the temporary memory is configured to store the outputs of the plurality of Huffman encoding units and then provide the outputs to the code connection unit.

9. The apparatus of claim 8, wherein the temporary memory comprises a register configured to store a valid bit size of last data and provide the valid bit size of the last data to the code connection unit when the codes of the outputs of the plurality of Huffman encoding units are connected by the code connection unit.

10. The apparatus of claim 1, wherein the compressed image signal comprises a Joint Photographic Experts Group (JPEG) encoded image signal.

11. The apparatus of claim 1, wherein the apparatus comprises an image encoder.

12. A method comprising:
chromatically subsampling an externally input image signal and arranging the image signal in units of a plurality of blocks;
performing Discrete Cosine Transform (DCT) with respect to the image signal divided into the plurality of blocks;
quantizing the DCT signals;
performing Differential Pulse Code Modulation (DPCM) with respect to the quantized signals;
performing Huffman encoding with respect to the DPCM signals; and then reconstructing the Huffman-encoded signals in constant bit units and outputting a compressed image signal.

13. The method of claim 12, wherein the DPCM is performed by obtaining a difference in DC level between the same color spaces of the quantized signals.

14. The method of claim 12, wherein the DPCM is performed after comparing any one of the blocks of the quantized signals with the other blocks and determining the input order of the blocks.

15. The method of claim 12, further comprising dividing the plurality of quantized signals and the Huffman-encoded signals in block units.

16. The method of claim 15, further comprising inserting a reset marker when the plurality of quantized signals are subjected to DPCM and the Huffman-encoded signals are reconstructed in constant bit units.

17. The method of claim 12, wherein the Huffman-encoded signals are divided in the same bit units as data used in an external memory for storing the compressed image signal so as to be reconstructed.

18. The method of claim 12, wherein the compressed image signal comprises a Joint Photographic Experts Group (JPEG) encoded image signal.

19. An apparatus comprising:
a block arrangement unit configured to chromatically subsample an externally input image signal and arrange the image signal in units of a plurality of blocks;
a plurality of Discrete Cosine Transform (DCT) units configured to perform DCT with respect to the image signal divided into the plurality of blocks;
a plurality of quantization units configured to quantize the outputs of the plurality of DCT units;
a delta modulation unit configured to perform Differential Pulse Code Modulation (DPCM) with respect to the outputs of the plurality of quantization units, the delta modulation unit including a circuit configured to divide the blocks of the outputs of the plurality of quantization units, insert a reset marker in constant units, and determine whether the blocks are subjected to the DPCM through the reset marker;
a plurality of Huffman encoding units configured to encode the outputs of the delta modulation units using a Huffman encoding method; and
a code connection unit configured to reconstruct the signals output from the plurality of Huffman encoding units in constant bit units and to output a compressed image signal, the code connection unit including a circuit configured to divide the outputs of the plurality of Huffman encoding units in constant block units and insert a reset marker.

20. The apparatus of claim 19, wherein the apparatus comprises an image encoder.
